(19) United States
(12) Patent Application Publication
(10) Pub. No.: US 2014/0032277 A1
(43) Pub. Date: Jan. 30, 2014

(54) METHODS, SYSTEMS AND COMPUTER-READABLE MEDIA FOR COMPUTING PERFORMANCE INDICATOR OF A RESOURCE

(71) Applicant: Infosys Limited, Bangalore (IN)

(72) Inventor: Patanjali Kashyap, Muzaffarpur (IN)

(21) Appl. No.: 13/945,815

(22) Filed: Jul. 18, 2013

(30) Foreign Application Priority Data
Jul. 26, 2012 (IN) 3058/CHE/2012

(51) Int. Cl. G06Q 10/06

(52) U.S. Cl. CPC G06Q 10/06393
USPC 705/7.39

(57) ABSTRACT

Technologies provide a method and system for computing a performance indicator of a resource. A plurality of parameters is defined for the performance indicator. A set of questions is presented to the resource, and a subset of questions is assigned to each of the dimension of the plurality of parameters, where each parameter can be associated with one or more dimensions. A response is received for each question from the resource, and a subset of responses for each dimension is aggregated to calculate a dimension score for the each dimension. The performance indicator is calculated from the dimension score of the each dimension of the plurality of parameters.

### FIELD

The technologies relate generally to a method and system of evaluating the corporate performance of an organization. More specifically, the present invention relates to a method and system for calculating a performance indicator of a human resource of the organization.

### BACKGROUND

A Balanced Scorecard has emerged as a strategic tool for an organization to measure corporate performance of an individual of the organization. Existing Balanced Scorecards usually, integrate actions of every individual of the organization, to track whether the actions of the individual are in furtherance to the goals of the organization. Such quantitative measures of calculating productivity of the individual merely reflect the intelligence quotient of the individual. However, studies have shown that the emotional, moral and social intelligence of the individual have a bearing effect on the corporate performance of the organization. Alternatively, in order to effectively measure the corporate performance of the individual, an emotional, moral and social quotient of the individual needs to be measured. A combined quotient that includes the intelligence, emotional, moral and social quotient of the individual is required in order to assess the corporate performance of the individual effectively. Further, a system that provides inputs for improving the emotional, social and moral intelligence of the individual is essential in order to improve the corporate performance of the individual.

Hence, there is a need for an alternative method and system that can measure the emotional, moral and social quotient of the individual of the organization. The alternate method and system must provide means for improving the measured emotional, moral and social quotient of the individual. Thus a method and system for effectively calculating the corporate performance of the individual is proposed.

### SUMMARY

The present invention provides a method and system for computing a performance indicator of a resource. In accordance with a disclosed embodiment, the method may include presenting a set of question to the resource, defining a plurality of parameters of the performance indicator, assigning a subset of questions from the set of questions, to each dimension of the plurality of parameters, whereby each parameter is associated with one or more dimensions, receiving a response to each question from the resource, aggregating a subset of responses to the subset of questions to calculate a dimension score of the each dimension, and calculating the performance indicator from the dimension score of the each dimension of the plurality of parameters.

In an additional embodiment, a system computing a performance indicator of a resource is disclosed. The system comprises a an output module configured to present a set of questions to the resource, an input module configured to receive a response to each question of the set of questions from the resource, a memory module configured to store the set of questions, and a plurality of parameters of the performance indicator, whereby each parameter is associated with one or more dimensions, a processing module configured to assign a subset of questions from the set of questions, to each dimension of the plurality of parameters, and a computing module configured to; aggregate a subset of responses to the subset of questions to calculate a dimension score of the each dimension; and calculate the performance indicator from the dimension score of the each dimension of the plurality of parameters.

These and other features, aspects, and advantages of the present invention will be better understood with reference to the following description and claims.

### BRIEF DESCRIPTION OF THE DRAWINGS

FIG. 1 is a flowchart illustrating an embodiment of a method of computing a performance indicator of a resource.

FIG. 2 is a flowchart illustrating a preferred embodiment of a method of computing a performance indicator of a resource.

FIG. 3 shows an exemplary system for computing a performance indicator of a resource.

FIG. 4 illustrates a generalized example of a computing environment 400.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for computing a performance indicator of a resource viz. a human resource. The performance indicator gives a measure of corporate performance of the human resource. The methods disclosed herein, incorporate a set of questions, wherein each question represents an emotional, a social, a vedic or a behavioral trait of the resource. A set of responses provided by the resource is preferably assessed against a predetermined scale to determine an emotional quotient, a social quotient, or a vedic quotient of the resource. The performance indicator can be calculated on the basis of the determined emotional, social and vedic quotient.

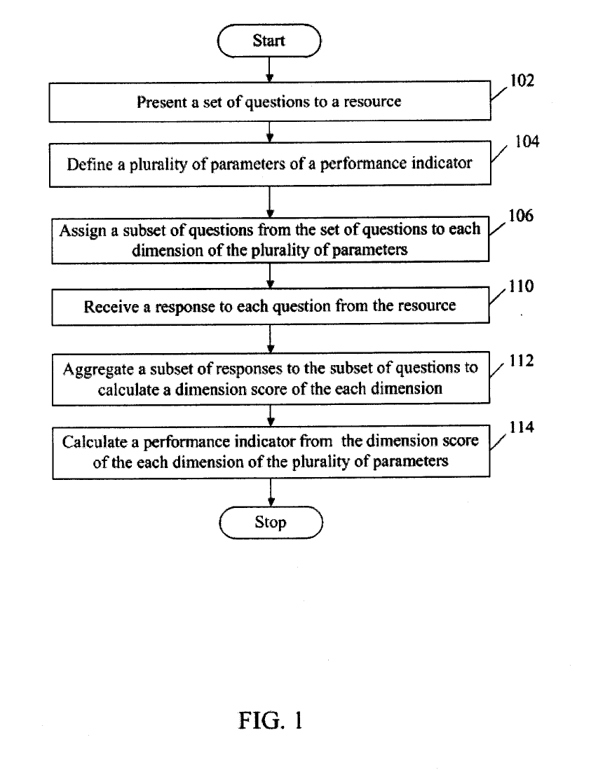

FIG. 1 is a flowchart that illustrates a method performed in computing a performance indicator of a resource in accordance with an embodiment of the present invention. In the disclosed embodiment the resource can refer to a human resource such as an employee of a corporate organization. Further, the performance indicator can give an indication of a performance capability or productivity of the resource. At step 102, a set of questions is presented to the resource. At step 104, a plurality of parameters is defined for the performance indicator. The plurality of parameters can include an emotional intelligence parameter, a Vedic intelligence parameter and a social intelligence parameter. Each of the plurality of parameters can include a one or more dimensions. Further, at step 106, a subset of questions from the set of questions can be assigned to each of the one or more dimensions of the plurality of parameters. At step 108, a response to each question of the set of questions can be received from the resource. A subset of responses to the subset of questions of the each one or more dimension can be aggregated to calculate a dimension score of the each one or more dimension at step 112. At step 114, the performance indicator can be calculated from the dimension score of the each one or more dimension.

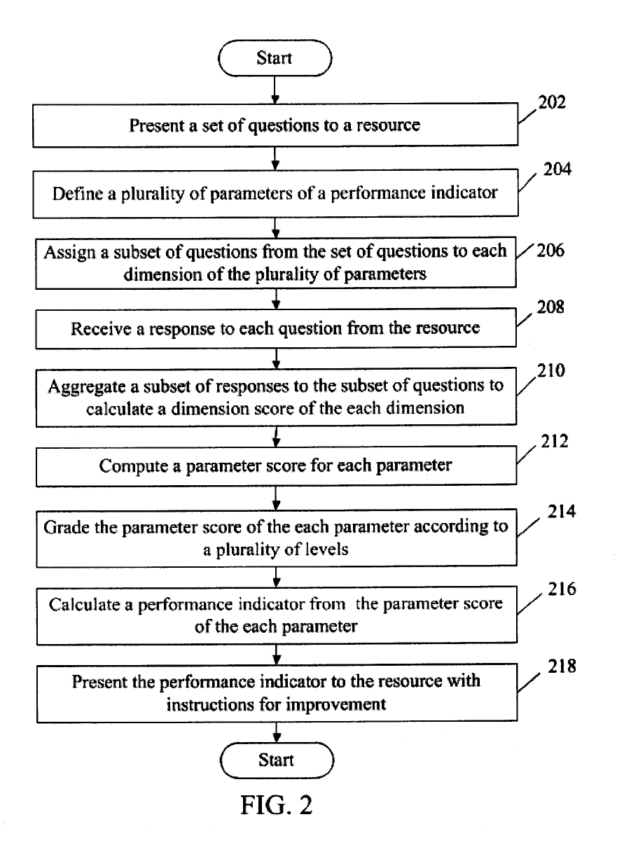

FIG. 2 illustrates an alternate embodiment of a method of practicing the instant invention. At step 202, a set of questions are presented to the resource, whose performance indicator needs to be calculated. The resource can be a human resource such as an employee of a corporate organization. The performance indicator of such a resource shall usually refer to a corporate performance ability or productivity of the resource, a criteria that shall determine the utility of the resource for the corporate organization in which the resource is usually employed. A plurality of parameters can be defined for the performance indicator at step 204. The plurality of parameters can include an emotional intelligence parameter, a social intelligence parameter and a vedic intelligence parameter. The emotional intelligence parameter (EQ) basically measures emotional intelligence or ability of an individual to identify, assess and control emotions of oneself, others and of groups. The social intelligence parameter (SQ) basically identify the ability of the individual to have a nourishing behavior towards other people such that the other people feel loved, respected, appreciated and valued. The SQ measures social intelligence of the individual. The individual possessing superior social skills, is usually in a better position to influence the other people effectively and thereby achieve their objectives by working from empathy. The individual with higher social intelligence can reduce conflict, create more efficient and effective collaboration amongst the other people in order to achieve goals of an organization or purpose. The Vedic Intelligence Parameter can include a moral intelligence parameter and a spiritual intelligence parameter. The moral intelligence parameter can depict a degree of strength of character of the individual. The strength of character usually defines an ability of the individual to overcome adversity, realize goals, capacity to interact with the other people and to determine how others may perceive us. The spiritual intelligence parameter usually measures a spiritual intelligence of the individual. The spiritual intelligence is usually an ability of the individual to adaptively use spiritual information and resource for problem solving and goal attainment. The individual with a high spiritual intelligence can focus on higher levels of consciousness for achieving righteous goals for the corporate organization. Each of the plurality of parameters can include one or more dimensions. In an instance the emotional intelligence parameter can include fifteen dimensions, the social intelligence parameter can include five dimensions and the moral intelligence parameter can include seven dimensions. Each of the dimensions shall clarify an aspect or virtue of an associated parameter. In the given instance, the fifteen dimensions of the emotional intelligence parameter can include, emotional self-awareness; assertiveness; independence or an ability to make decisions based on one's own assessment and understanding of a situation; self-actualization meaning a competency of being able to set goals for oneself and meeting the goals; empathy viz. an ability to listen and pay attention to the other people's feelings; social responsibility meaning a competency of being able to care and discipline our work efforts to serve the interests of individuals and groups that lie outside the field of our personal needs, goals and concerns; interpersonal relationships meaning a competency of the individual to initiate and sustain lasting friendships; stress tolerance viz skill to keep unavoidable pains and intrusions of life from weakening our physical and emotional health; impulse control viz. an ability to regulate the buildup of nervous energy that accompanies without projecting it as anger, anesthetizing it through self-medication or distracting ourselves from it; reality testing viz. a competency that enables the individual to correctly evaluate the nature of the current situation; flexibility viz. a skill that allows the individual to change direction rapidly without resistance; problem solving; optimism; happiness and self-regard viz. a skill of liking oneself. Further, in the given instance the seven dimensions of the moral intelligence parameter include empathy viz. an ability to identify with other people's concerns; conscience viz. an ability to know the right path of action; self-control viz. an ability to fully understand oneself and to use the information to manage emotions productively; respect viz. a competency to treat people in a courteous and considerate way; kindness viz. an ability of demonstrate concern about welfare and feelings of the other people; fairness viz. an ability to be open-minded and act in a just manner; and tolerance viz. an ability to respect dignity and rights of all people. Further in the given instance, the five dimensions of the social intelligence parameter include situational radar viz. an ability to read situations from the social context; presence viz. an external sense of one's self; authenticity; clarity; and empathy. In order to measure each of the one or more dimensions of each of the plurality of parameters, a subset of questions from the set of questions can be assigned to each of the one or more dimensions, at step 206. The response to each of the set of questions can be received from the resource, in step 208. The response can comprise one of a set of graded numbers, whereby each graded number signifies an ability of the resource to handle a situation proposed by the each question. The ability can be expressed in terms of a ‘Very slight ability’, an ‘OK Ability’, a ‘Moderate Ability’, a ‘High Ability’ and an ‘Excellent Ability’. The graded number can be associated with each of the aforementioned abilities. The response to the subset of questions of a particular dimension can be aggregated to achieve a dimension score of the particular dimension, at step 210. On achieving the dimension score of the each dimension, a parameter score for each of the plurality of parameters, can be calculated by a process of summation at step 212. For instance the parameter score of the emotional intelligence parameter known as an emotional intelligence score can be calculated by summing up each dimension score of the fifteen dimensions of the emotional intelligence parameter. Similarly, the social intelligence score can be calculated by summing up each dimension score of the five dimensions of the social intelligence parameter. The parameter score of each of the plurality of parameters can be rated against a predetermined scale, wherein the predetermined scale can include a plurality of levels, at step 214. Each level of the plurality of levels can signify strength of the associated parameter viz. strength of the emotional intelligence of the resource. The strength of the emotional intelligence can be termed as an emotional quotient. Similarly, the strength of the social intelligence can be termed as a social quotient, and strength of the vedic intelligence can be termed as a vedic quotient. In an instance, the plurality of levels, for the emotional intelligence parameter, can be as follows: a parameter score of:
above 70, can signify an excessively high emotional quotient,
55 to 69, can signify a very high emotional quotient,
40-54, can signify a high emotional quotient,
25-39, can signify an above average emotional quotient,
10-24, can signify an average emotional quotient,
0-9, can signify a below average emotional quotient,
below 0, can signify a low emotional quotient.

At step 216, the performance indicator is calculated from each of the computed parameter scores. A weighted average method, a summation process or any existing mathematical technique may be followed for the purpose of calculating the performance indicator from the computed parameter scores. At step 218, the performance indicator can be presented to the resource, with instructions related to improving the emotional quotient, the social quotient and the vedic quotient of the resource. The instructions for improvement can include one or more training programs designed to develop the emotional quotient, the social quotient, and the vedic quotient of the resource. The one or more training programs can be customized to each of the resource based on the performance indicator of the resource. On completion of the one or more training programs, the resource may be reevaluated by going through steps 202 to 218, in order to recalculate the performance indicator. Further, on completion of the one or more training programs, the resource may be reevaluated by a peer and a manager of the resource, and a value of the performance indicator shall be computed. A composite value of the performance indicator shall indicate whether the emotional quotient, the social quotient and the vedic quotient of the resource has improved to standards or whether further training programs would be essential for the resource.

The result of the abovementioned method viz. the performance indicator can be integrated with the output of an existing balance scorecard viz. an intelligence quotient of the resource in order to get a comprehensive score or a composite score. The composite score shall signify the overall productivity of the resource as it shall include the emotional quotient, the social quotient, the moral quotient, a spiritual quotient and the intelligence quotient of the resource. Such composite score shall be more effective for the purpose of measuring whether the resource shall have a high corporate performance and productivity for the organization.

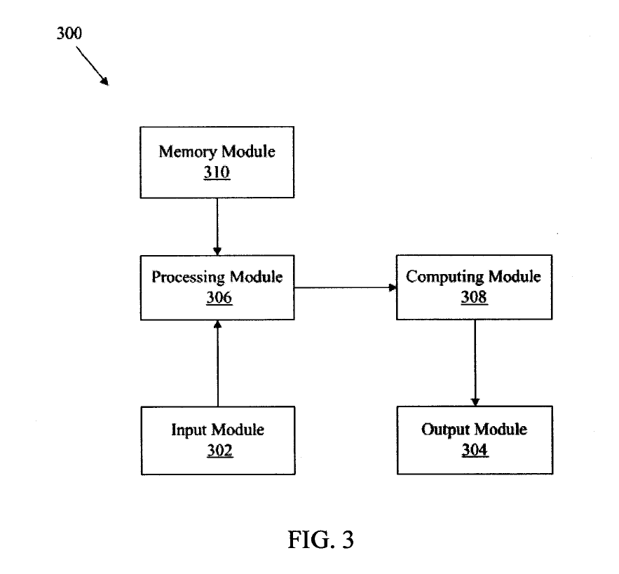

FIG. 3 illustrates an exemplary system 300 in which various embodiments of the invention can be practiced. The exemplary system 300 includes an output module 304, an input module 302, a processing module 306, a computing module 308, and a memory module 310. The output module 304, can be configured to present a set of questions to a resource whose performance indicator is to be computed. The input module 302, can be configured to receive a response to each question of the set of questions from the resource. The memory module 310, can be configured to store a set of questions and a plurality of parameters of the performance indicator. Each of the plurality of parameters can include a set of dimensions which define the parameter. The set of dimensions can also be stored in the memory module 310. The processing module 306, can be configured to assign a subset of questions from the set of questions to each dimension of the plurality of parameters. The computing module 308, can be configured to calculate the performance indicator of the resource. The output module 304, can be configured to present the calculated performance indicator to the resource.

The plurality of parameters can include an emotional intelligence parameter, a Vedic intelligence parameter and a social intelligence parameter. The Vedic intelligence parameter can include a moral intelligence parameter and a spiritual intelligence parameter. The computing module 308, can be further configured to compute an emotional intelligence score from the dimension score of the each dimension of the emotional intelligence parameter, a vedic intelligence score from the dimension score of the each dimension of the spiritual intelligence parameter and the moral intelligence parameter; and a social intelligence score from the dimension score of the each dimension of the social intelligence parameter. The Vedic intelligence score can include a moral intelligence score and a spiritual intelligence score corresponding to a moral intelligence parameter and a spiritual intelligence parameter respectively. The computing module 308 can be further configured to grade the emotional intelligence score, the social intelligence score and Vedic intelligence score according to a plurality of levels, whereby each level signify a strength of an emotional quotient, a social quotient, and a vedic quotient of the resource respectively. The response can include one of a set of graded numbers, whereby each graded number signifies an ability of the resource to handle a situation proposed by the each question. The ability can be represented as one of a ‘Very slight ability’, an ‘OK Ability’, a ‘Moderate Ability’, a ‘High Ability’ and an ‘Excellent Ability’. The output module 304 can be further configured to output or present, the performance indicator to the resource along with instructions related to improving the emotional quotient, the social quotient and the vedic quotient of the resource. Means of outputting the performance indicator can be through a graphical user interface. The instructions can include one or more training programs, the one or more training programs being designed to develop the emotional quotient, the social quotient, and the vedic quotient of the resource. Finally, the computing module 308, can be further configured to, combine the calculated performance indicator with an intelligence quotient of the resource to output a composite score, depicting an overall performance characteristic of the resource. The intelligence quotient can be determined by any of the balance scorecards existing in prior art.

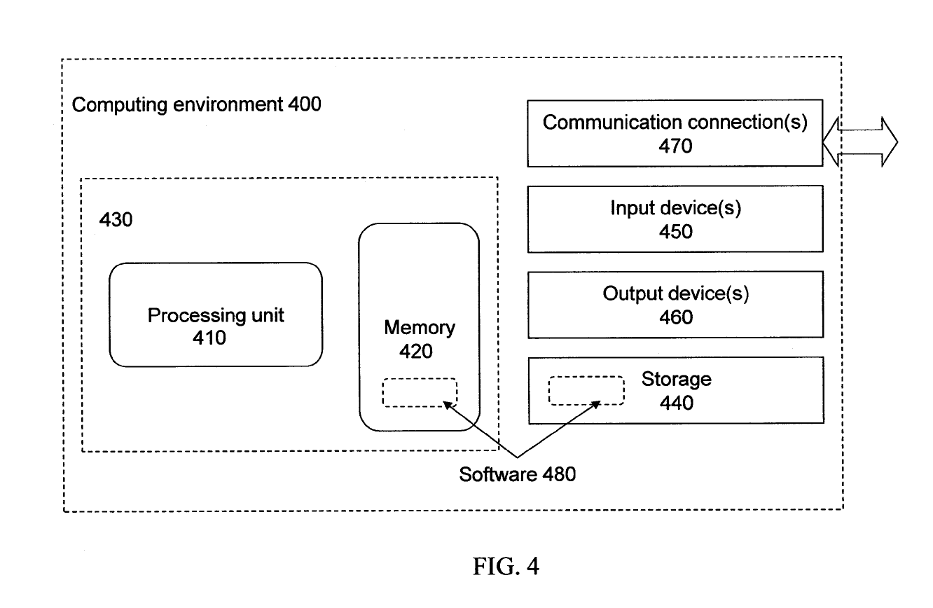

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

1. A method for computing a performance indicator of a resource, the method comprising:
presenting a set of questions to the resource;
defining a plurality of parameters of the performance indicator;
assigning a subset of questions from the set of questions, to each dimension of the plurality of parameters, whereby each parameter is associated with one or more dimensions;
receiving a response to each question from the resource;
aggregating a subset of responses to the subset of questions to calculate a dimension score of the each dimension; and
calculating the performance indicator from the dimension score of the each dimension of the plurality of parameters.

2. The method of claim 1, wherein the plurality of parameters comprise an emotional intelligence parameter, a Vedic intelligence parameter and a social intelligence parameter.

3. The method of claim 2, wherein the Vedic intelligence parameter includes a moral intelligence parameter and a spiritual intelligence parameter.

4. The method of claim 3, further comprising:
computing an emotional intelligence score from the dimension score of the each dimension of the emotional intelligence parameter;
computing a vedic intelligence score from the dimension score of the each dimension of the spiritual intelligence parameter and the moral intelligence parameter; and
computing a social intelligence score from the dimension score of the each dimension of the social intelligence parameter.

5. The method of claim 4, wherein the Vedic intelligence score comprises of a moral intelligence score and a spiritual intelligence score.

6. The method of claim 5, further comprising:
grading the emotional intelligence score, the social intelligence score and Vedic intelligence score according to a plurality of levels, whereby each level signify a strength of an emotional quotient, a social quotient, and a vedic quotient of the resource respectively.

7. The method of claim 1, wherein the response comprises one of a set of graded numbers, whereby each graded number signifies an ability of the resource to handle a situation proposed by the each question.

8. The method of claim 7, wherein the ability comprises one of a ‘Very slight ability’, an ‘OK Ability’, a ‘Moderate Ability’, a ‘High Ability’ and an ‘Excellent Ability’.

9. The method of claim 4, further comprising:
presenting the performance indicator to the resource with instructions related to improving the emotional quotient, the social quotient and the vedic quotient of the resource.

10. The method of claim 9, wherein, the instructions comprise one or more training programs, the one or more training programs being designed to develop the emotional quotient, the social quotient, and the vedic quotient of the resource.

11. The method of claim 1, further comprising integrating an intelligence quotient of the resource with the performance indicator to output a composite score.

12. A system for computing a performance indicator of a resource, the system comprising:
an output module configured to present a set of questions to the resource;
an input module configured to receive a response to each question of the set of questions from the resource;
a memory module configured to store the set of questions, and a plurality of parameters of the performance indicator, whereby each parameter is associated with one or more dimensions;
a processing module configured to assign a subset of questions from the set of questions, to each dimension of the plurality of parameters; and
a computing module configured to:
(i) aggregate a subset of responses to the subset of questions to calculate a dimension score of the each dimension; and
(ii) calculate the performance indicator from the dimension score of the each dimension of the plurality of parameters.

13. The system of claim 12, wherein the plurality of parameters comprise an emotional intelligence parameter, a Vedic intelligence parameter and a social intelligence parameter.

14. The system of claim 12, wherein the Vedic intelligence parameter includes a moral intelligence parameter and a spiritual intelligence parameter.

15. The system of claim 14, wherein the performance indicator comprises: an emotional intelligence score, a Vedic intelligence score, and a social intelligence score, wherein;
the emotional intelligence score includes a summation of the dimension score of the each dimension of the emotional intelligence parameter,
the Vedic intelligence score includes a summation of the dimension score of the each dimension of the spiritual intelligence parameter, and the moral intelligence parameter, and
the social intelligence score includes a summation of the dimension score of the each dimension of the social intelligence parameter.

16. The system of claim 15, wherein the Vedic intelligence score comprises a moral intelligence score and a spiritual intelligence score.

17. The system of claim 16, further comprising:
a grading module, configured to grade the emotional intelligence score, the social intelligence score and Vedic intelligence score according to a plurality of levels, whereby each level signify a strength of an emotional quotient, a social quotient and a vedic quotient of the resource respectively.

18. The system of claim 12, wherein the response comprises one of a set of graded numbers, whereby each graded number signifies an ability of the resource to handle a situation proposed by the each question.

19. The system of claim 18, wherein the ability comprises one of a ‘Very slight ability’, an ‘OK Ability’, a ‘Moderate Ability’, a ‘High Ability’ and an ‘Excellent Ability’.

20. The system of claim 17, wherein the output module is further configured to:
present the performance indicator to the resource with instructions related to improving the emotional quotient, the social quotient and vedic quotient of the resource.

21. The system of claim 20, wherein the instructions comprise one or more training programs, the one or more training programs being designed to develop the emotional quotient the social quotient and vedic quotient of the resource.

22. The system of claim 12, further comprising integrating an intelligence quotient of the resource with the performance indicator to output a composite score.

23. A computer program product consisting of a plurality of program instructions stored on a non-transitory computer-readable medium that, when executed by a computing device, performs a method of computing a performance indicator of a resource, the method comprising:
presenting a set of questions to the resource;
defining a plurality of parameters of the performance indicator;
assigning a subset of questions from the set of questions, to each dimension of the plurality of parameters, whereby each parameter is associated with one or more dimensions;
receiving a response to each question from the resource;
aggregating a subset of responses to the subset of questions to calculate a dimension score of the each dimension; and
calculating the performance indicator from the dimension score of the each dimension of the plurality of parameters.

24. The computer program product of claim 23, wherein the plurality of parameters comprise an emotional intelligence parameter, a Vedic intelligence parameter and a social intelligence parameter.

25. The computer program product of claim 24, wherein the Vedic intelligence parameter includes a moral intelligence parameter and a spiritual intelligence parameter.

26. The computer program product of claim 25, wherein the performance indicator comprises: an emotional intelligence score, a Vedic intelligence score, and a social intelligence score, wherein;
the emotional intelligence score includes a summation of the dimension score of the each dimension of the emotional intelligence parameter,
the Vedic intelligence score includes a summation of the dimension score of the each dimension of the spiritual intelligence parameter, and the moral intelligence parameter, and
the social intelligence score includes a summation of the dimension score of the each dimension of the social intelligence parameter.

27. The computer program product of claim 26, wherein the Vedic intelligence score comprises of a moral intelligence score and a spiritual intelligence score.

28. The computer program product of claim 27, wherein the method further comprises:
grading the emotional intelligence score, the social intelligence score and Vedic intelligence score according to a plurality of levels, whereby each level signify a strength of an emotional quotient, a social quotient, and a vedic quotient of the resource respectively.

29. The computer program product of claim 23, wherein the response comprises one of a set of graded numbers, whereby each graded number signifies an ability of the resource to handle a situation proposed by the each question.

30. The computer program product of claim 29, wherein the ability comprises one of a ‘Very slight ability’, an ‘OK Ability’, a ‘Moderate Ability’, a ‘High Ability’ and an ‘Excellent Ability’.

31. The computer program product of claim 27, wherein the method further comprises:
presenting the performance indicator to the resource with instructions related to improving the emotional quotient, the social quotient and the vedic quotient of the resource.

32. The computer program product of claim 31, wherein the instructions comprise one or more training programs, the one or more training programs being designed to develop the emotional quotient the social quotient and vedic quotient of the resource.

33. The computer program product of claim 23, wherein the method further comprises:
further comprising integrating an intelligence quotient of the resource with the performance indicator to output a composite score.
